(19) United States
(12) Patent Application Publication
(10) Pub. No.: US 2004/0113418 A1
(43) Pub. Date: Jun. 17, 2004

(54) Combination advertising card and collar stay

(76) Inventor: Andrew G. Bullen, Ramsey, NJ (US)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/319,336

(22) Filed: Dec. 13, 2002

(51) Int. Cl. G09F 1/00

(52) U.S. Cl. 283/56

(57) ABSTRACT

A device for use as an advertising card, such as a business card, or one or more collar stays, as well as a method of using such device, are disclosed. In one form, the device comprises a resilient, flexible sheet member having a first and second opposing edges and a third and fourth opposing edges, the first and second opposing edges forming a width, the third and fourth opposing edges forming a height, the width being greater than the height, and one or more detachable regions within the sheet member, each detachable region having an elongated rectangular shape including two long edges and two short edges, wherein a short edge forms a symmetrically tapered point is disclosed. The flexible sheet member may be composed of cardboard stock, plastic or metal, and may bear imprinted information on either the front or back side or both.

### BACKGROUND OF THE INVENTION

The present invention relates to a device that is easily transformable from an advertising card into one or more pairs of collar stays, while the untransformed device functions as an advertising card.

Collar stays are typically used to add stiffness and a crisper look to a shirt collar. Conventional collar stays typically are formed as a rectangular wafer approximately two to three inches by one quarter to one third inch, made of plastic, metal, wood or cardboard. They typically are paired and have rounded corners, so as not to tear the fabric of the shirt. One end of each stay is usually somewhat pointed to adapt to the pointed end of a typical shirt collar, while the opposite end is typically squared.

While conventional collar stays function as designed, difficulties may arise when the shirt is laundered. Many collar stays are removable, and are either intentionally removed when the shirt is laundered, or may unintentionally fall out during laundering. In either instance, the collar stays so removed must be reinserted after laundering. A traveler might not have the time or forethought to check that their removable collar stays have been reinserted after laundering on every shirt they pack for their travel.

Additionally, a shirt might be laundered with one or both collar stays in the collar of the shirt. The laundering process may itself lead to damage to the collar stays, such as bending, breaking, or disintegration. One or more damaged collar stays may cause a shirt to look undesirable. A traveler may also not have the time or forethought to check that their collar stays are undamaged after laundering.

While collar stays are available in several sizes, packing such collar stays requires that the traveler exercise forethought in their packing process. It is not unusual for a traveler to arrive at their destination only to find that a shirt they desire to wear is missing one or more collar stays. It is also not unusual for the traveler to then find they have neglected to check for this and to pack collar stays in advance.

Although collar stays are available for purchase in numerous locations, access to such locations may be limited to the traveler because of limited business hours and price considerations.

Alternatively, some collar stays are permanently sewn into the shirt collar. These also encounter difficulties. For example, when used after several launderings, such collar stays may become damaged or bent. This may lead to the need to cut a collar seam to replace the damaged or bent collar stay. Also, a traveler might not have the time or forethought to check the condition of shirts with permanently attached collar stays prior to packing for their trip.

Advertising cards, such as conventional business cards are frequently carried and acquired by travelers, especially business travelers. Such travelers often dispose of acquired business cards once their business is complete or the information from the business card is entered into the traveler's address book, rolodex, etc. There is a lack of incentive for a recipient of a conventional business card to retain the card for other than informational purposes.

### SUMMARY OF THE INVENTION

In accordance with one aspect of the present invention, the invention includes one or more collar stays. The collar stays are formed on a flexible sheet member having a first and second opposing edges and a third and fourth opposing edges. The first and second opposing edges form a width, the third and fourth opposing edges form a height, the width being greater than the height. One or more detachable regions are formed within the sheet member, each having an elongated rectangular shape including two long edges and two short edges. One of the short edges being shaped to form a symmetrically tapered point.

Also included are variations of the collar stays in which the flexible sheet member is composed of a cardboard stock, or a plastic, or metal, or a material that is cellulose-based.

Additionally, another aspect of the present invention includes collar stays as described above in which the flexible sheet member includes a front side and a back side, the front side bearing imprinted information.

The imprinted information of an aspect of the invention may include the use of colored inks.

Another aspect of the invention includes collar stays, as described above, in which the front side includes information imprinted within the detachable regions.

Another aspect of the invention includes collar stays, as described above, in which the back side includes imprinted information.

Another aspect of the invention includes collar stays, as described above, wherein the back side of the flexible sheet member bears information imprinted in at least one of the detachable regions.

Another aspect of the invention includes the collar stays as described above, in which the detachable regions are formed by stamping the flexible sheet member.

Additionally, another aspect of the invention includes the collar stays as described above, wherein the detachable regions are formed by cutting away a portion of the flexible sheet member.

Another aspect of the invention includes the collar stays as described above, in which the detachable regions are formed by molding the flexible sheet member.

Another aspect of the invention includes the collar stays as described above, in which the detachable regions are formed by partially cutting the flexible sheet member.

In another aspect of the invention, a device for use as a business card having one or more collar stays is provided. It includes a card having opposing parallel first and second edges and opposing parallel third and fourth edges, and one or more detachable regions, with each detachable region being rectangular and having four sides, with a long bilateral axis and a short bilateral axis. One side along the long bilateral axis forms a rounded point.

Additionally, another aspect of the invention includes the business card device as described above, wherein the device is composed of cardboard stock.

Another aspect of the invention includes the business card device as described above, including a front side and a back side, with printing on at least one side.

Another aspect of the invention includes the business card device as described above, in which the detachable regions are formed by partially cutting the card.

In another aspect of the invention, an advertising device having one or more collar stays formed therewith, in which the device comprises a substantially planar member delineating a geometric shape having at least one separation line formed within the member delineating a portion of the member in the shape of a collar stay, whereby the portion of the member can be separated from a remaining portion of the member to provide at least one collar stay is provided.

Another aspect of the invention includes a method of forming one or more collar stays from a flexible sheet member comprising an advertising device. The method includes

delineating one or more collar stay shapes on the flexible sheet member, weakening the flexible sheet member along the collar stay shapes delineated thereupon, and separating the collar stays from the flexible sheet member along the weakened collar stay shapes.

It is understood that both the foregoing general description and the following detailed description are exemplary and are intended to provide further explanation of the invention claimed.

### BRIEF DESCRIPTION OF THE DRAWINGS

The accompanying drawings, which are incorporated in and constitute part of this specification, are included to illustrate and provide a further understanding of the system and method of the invention. Together with the description, the drawings serve to explain the principles of the invention.

FIG. 1 is an illustration of the front side of a business card including a pair of collar stays according to an embodiment of the present invention;

FIG. 2 is an illustration of the back side of a business card including a pair of collar stays according to an embodiment of the present invention;

FIG. 3 is an illustration of the front side of a business card including a single collar stay according to an embodiment of the present invention; and

FIG. 4 is an illustration of the front side of a business card including multiple collar stays according to an embodiment of the present invention.

FIG. 5 is an illustration of the front side of a business card including an exemplary collar stay with alternative selectable length according to an embodiment of the present invention.

### DETAILED DESCRIPTION

The present invention advantageously provides collar stays that a business traveler does not need to separately consider and pack prior to their travel, but which nonetheless are readily available anywhere they go.

It also advantageously relieves the traveler from the necessity of checking every shirt they pack to insure that the removable collar stays have been reinserted after laundering.

Additionally, in the case of one or more damaged removable collar stays, the present invention relieves the traveler from the necessity of discovering damaged collar stays prior to or during packing for their trip.

The present invention also advantageously provides the traveler with collar stays they do not need to particularly consider in advance of their travels, but which nonetheless are readily available anywhere they go.

The present invention also provides the traveler or any person with an advertising card such as a business card which can also act as collar stays. Such a device is easily transformable from a business card into a set of collar stays, and when in collar stay form, provides adequate support for a shirt collar. The present invention thus advantageously provides the person with a business card having additional value to the recipient of the business card. This additional value causes the business card to be more likely to be retained by the recipient, which, in turn, conveys a business advantage to the person or business whose information is printed thereupon.

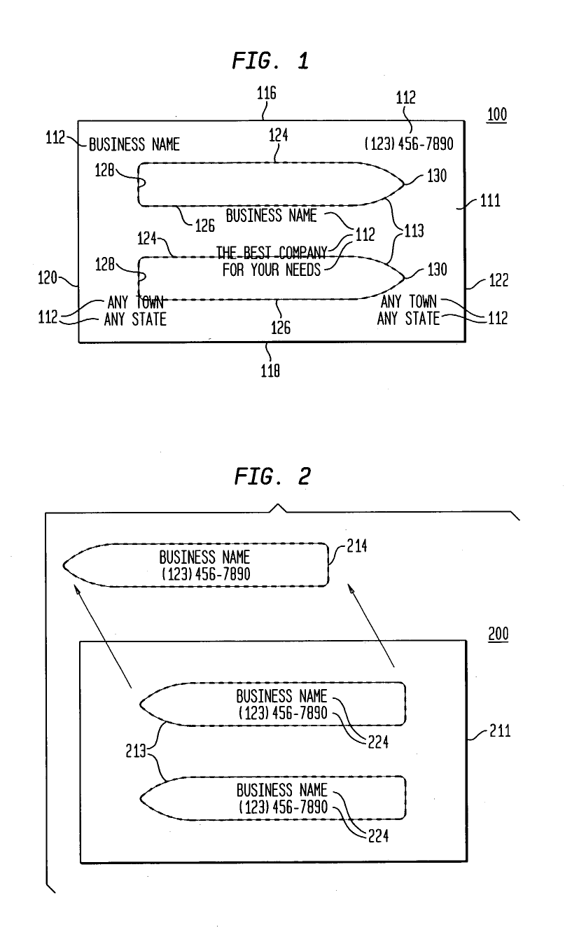

FIG. 1 illustrates the front side of a device 100 operating as a business card with a pair of collar stays according to an embodiment of the present invention. In a preferred form, and as illustrated in FIG. 1, the device 100 may be used as a promotional device or business card. In this form, the device 100 comprises a substantially flat piece of rectangular material on which printing 112 or other advertisements may be located. The card preferably has a first edge 116 and opposing second edge 118, and a third edge 120 and opposing fourth edge 122. While the preferred form of the device 110 is a rectangle with parallel opposing edges 116, 118 and 120, 122, it is, of course, possible for the edges to not be parallel, e.g., round, oval, polygonal and the like. Further, while it is preferred that the edges 116, 118, 120, 122 be straight, it is possible for the edges to take on other forms. For example, one or more of the edges could be somewhat arcuate, or include one or more projecting areas, or be shaped such that the card takes on a tapered form in one or more areas.

Preferably, the card has dimensions of about ½″ to 3″ from third edge 120 to fourth edge 122, and 2″ to 4″ from first edge 116 to second edge 118. Most preferably, the card 112 has dimensions of a standard business card, i.e. about 2″ from third edge 120 to fourth edge 122, and about 3.5″ from first edge 116 to second edge 118. Of course, the card can have any of a variety of dimensions.

The card is preferably made of cardboard or stiff paperboard. It may alternatively be composed of plastic and/or rubber, or a similar flexible, tear-resistant, waterproof material. One material which is believed to be suitable is Lexan™. The card could comprise a paper card which has been laminated with a plastic material, or could be made from numerous other materials such as aluminum or the like. The card is most preferably about 1.0-1.5 mm in thickness, although an alternative thickness may also be used. In one particularly preferred embodiment the card is made of standard cardboard or other cellulose-based material used for business cards, which advantageously provides a stiffness suitable for collar stays at a reasonable expense.

Further, the card preferably includes printing 112. The card may be of a translucent material having colored printing 112 thereon, or be made of a colored plastic or other material with varied colored printing 112 thereon. Although any ink may be used for the printing 112 on the card, it is preferable to use an permanent ink that does not rub or wash off. When the collar stays are used in a shirt, any other type of ink might be transferred from a collar stay to the shirt, thereby causing damage.

Preferably, and as illustrated in FIG. 1, the card includes a resilient and flexible sheet 111 having one or more detachable regions 113. In the preferred form, two detachable regions 113 are formed on the card in the elongated rectangular shape of typical collar stays. These detachable regions are each preferably rectangular is shape, having two long edges 124, 126 as well as two shorter edges 128, 130. One of the shorter edges 130 is tapered to form a rounded point.

It is preferred that the detachable regions 113 be created by forming separating lines on the card. Separating lines are lines of structural weakness such that facilitate the mechanical separation or parting of the detachable region delineated by the separating lines from the remainder of the card. Separating lines may be formed by cutting or stamping material from the card, although any means known to one skilled in the art may be used. For example, the card and detachable regions 113 delineated by separating lines may be created during a molding process or by forming the separating lines using closely-spaced perforations. When using a partial cutting or multiple perforation technique to create the separating lines, it is preferred that when the detachable regions 113 are detached, their edges 124, 126, 128, 130 are as smooth as practical. In several embodiments there will be some edge roughness as a result of separating the detachable regions 113. This roughness may complicate the process of inserting the collar stays into a collar. Collar stays with smooth edges 124, 126, 128, 130 are thus preferable due in part to their ease of insertion into a collar.

A molding process may alternatively be used to form separating lines. Molding processes are known in the art, and are most useful when the flexible sheet 111 forming the card involves a pulp or molten phase in its creation process. By molding lines of weakness, wherein the sheet material has less thickness along the line of separation than other areas of the sheet, these lines of weakness form separating lines.

“Separating lines”, as the term is used herein, is also intended to apply to a preferred embodiment in which one or more detachable regions may be delineated by a single contiguous separating line.

In operation, a person may preferably use the device 100 as a standard business card. For example, the device may carry information regarding a business, including name, address, telephone and facsimile numbers, as well as other information. It may also include a logo or other symbol. It may even include a drawing or photograph. The device 100 may be used to advertise or to otherwise convey information to its recipient. Unlike a standard business card, however, the recipient is preferably provided with an added incentive to retain the device 100 due to its convertibility into useful collar stays.

In order to use the collar stays of a preferred embodiment of the device 100, the person holding the card removes the detachable regions 113 along their separating lines. These regions 113, after being detached, form collar stays, which may then be placed into the collar of a shirt.

FIG. 2 illustrates the back side of a business card 211 including a pair of collar stays according to an embodiment of the present invention. The business card preferably includes the detachable regions 213, which form collar stays when detached from the card 211.

An added advertising feature is available in a preferred embodiment of the business card 211 depicted in FIG. 2. The detachable regions 213 may include printing or engraving of information or advertising 224. Although FIG. 2 depicts the printing of a business name and telephone number, any information may be alternatively printed thereupon.

When a collar stay 214 is detached from the business card 211, the printed information is preferably readable on the collar stay 214. Other embodiments exist in which there is no printing on the reverse side of the detachable regions 213.

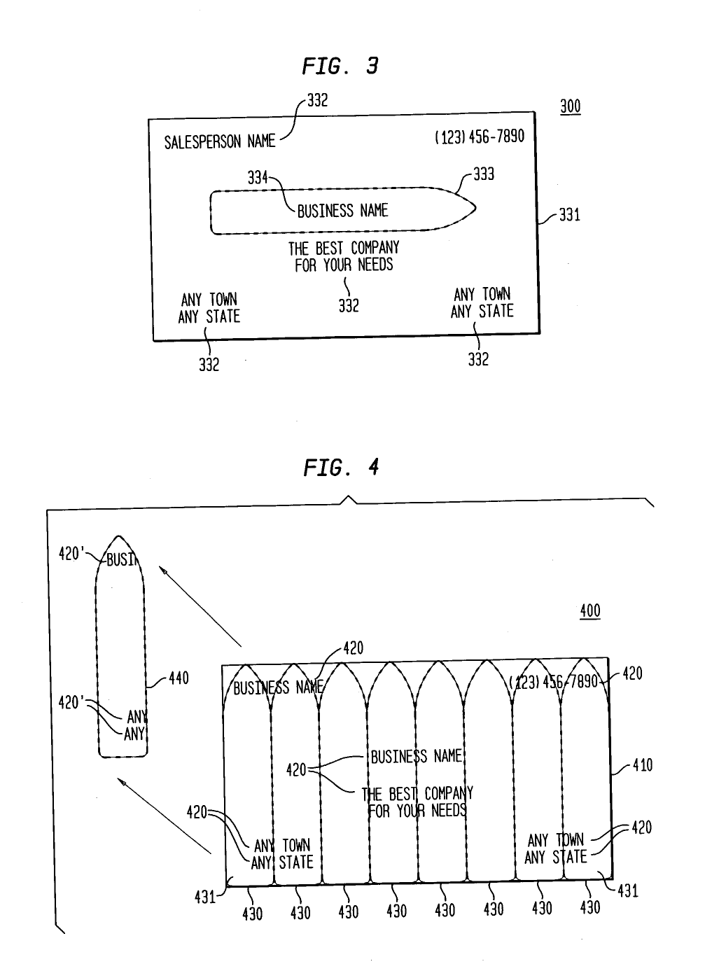

FIG. 3 illustrates the front side of a business card 300 of an exemplary embodiment including a single detachable region 333 which may be detached to form a single collar stay. A business card 300 may contain any number of detachable regions 333 capable of fitting within the business card 300. In this embodiment a single collar stay is useful for a business traveler who needs a single collar stay as, for example, in an emergency wherein the traveler has lost only one of their collar stays. This illustration also exemplifies that any text or images 332 may be placed on the face of the business card 300. It is also preferable, but not required, that text may be printed on the card 300 in such a manner that it is legible on the detachable region 334, even after the region 333 is detached to form a collar stay.

FIG. 4 illustrates the front side of a business card 400 including multiple collar stays according to a preferred embodiment of the present invention. In this exemplary embodiment, the number of detachable regions 430 that may each be detached to form a collar stay 440 is maximized by packing the detachable regions 430 tightly together on the surface of the business card 410.

This embodiment also includes printing 420 on the front of the business card 410, and may optionally include printing on the back of the card (not depicted). In this form, the detachable regions 420 are preferably detached first from an end 431. It is thus preferable, but not mandatory, that the printing 420 on the front of the card 410 be positioned away from the ends 431, so as to ensure that the printing 420 on the remains of the card 410 after one or more collar stays are detached is still readable.

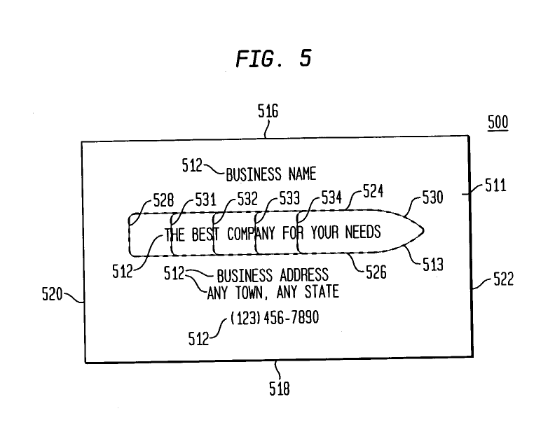

FIG. 5 illustrates the front side of a business card 500 including multiple separating lines for alternative selection of collar stay length, in accordance with an embodiment of the invention. Preferably, the card includes a resilient and flexible sheet 511 having one or more detachable regions 513. In a preferred form, a detachable region 513 is formed on the card in the elongated rectangular shape of typical collar stays. This detachable region is each preferably rectangular is shape, having two long edges 524, 526 as well as two shorter edges 528, 530. One of the shorter edges 530 is tapered to form a rounded point.

This embodiment also preferably includes printing 512 on the front of the business card 500, and may optionally include printing on the back of the card (not depicted). In this form, the detachable region 513 is preferably first detached from the flexible sheet 511. The detachable region 513 then forms a collar stay. The collar stay may then be truncated to any of an alternative selection of lengths by selecting one of the separating lines 531, 532, 533, 534 at which to divide the collar stay into two portions. The portions having the shorter edge 530 with rounded point is thus usable as a collar stay of selected length, while the other portion may be discarded. It is preferable, but not mandatory, that the separating lines 531, 532, 533, 534 are spaced regularly at ½-inch intervals, although any number or spacing of such separating lines may alternatively be used. Similarly, the collar stay may be used whole, without truncation, when the full length collar stay is desired.

It is also preferable in this embodiment that the separating lines 531, 532, 533, 534 be formed in a manner wherein a collar stay which still incorporates any of these separating lines 531, 532, 533, 534 is not significantly structurally weakened. This may be accomplished by several methods known to the art, e.g., whereby a separating line formed with perforations uses a lowered perforation density, etc.

It will be understood that the above described arrangements of apparatus and the method thereof are merely illustrative of applications of the principles of this invention and many other embodiments and modifications may be made without departing from the spirit and scope of the invention as defined in the claims.

Although the invention herein has been described with reference to particular embodiments, it is to be understood that these embodiments are merely illustrative of the principles and applications of the present invention. It will be apparent to those skilled in the art that various modifications and variations can be made in the apparatus and methods of the present invention without departing from the spirit and scope of the invention. Thus, it is intended that the present invention include modifications and variations that are within the scope of the appended claims and their equivalents.

1. An advertising card having one or more collar stays comprising:
a resilient, flexible sheet member having first and second opposing edges and third and fourth opposing edges, the first and second opposing edges forming a width therebetween, the third and fourth opposing edges forming a height therebetween, the width being greater than the height; and
one or more detachable regions within the sheet member, each detachable region having an elongated rectangular shape including two long edges and two short edges, wherein at least one short edge forms a symmetrically tapered point.

2. The advertising card according to claim 1, wherein the advertising card comprises a business card.

3. The advertising card according to claim 1, wherein the flexible sheet member is composed of a cardboard stock.

4. The advertising card according to claim 1, wherein the flexible sheet member is composed of plastic.

5. The advertising card according to claim 1, wherein the flexible sheet material is cellulose-based.

6. The advertising card according to claim 1, wherein the flexible sheet material is metallic.

7. The advertising card according to claim 1, wherein the flexible sheet member includes a front side and a back side, the front side bearing imprinted information.

8. The advertising card according to claim 7, wherein the imprinted information is in at least one color.

9. The advertising card according to claim 7, wherein the imprinted information on the front side includes information imprinted in at least one of the detachable regions.

10. The advertising card according to claim 7, wherein the back side of the flexible sheet member bears imprinted information.

11. The advertising card according to claim 10, wherein the imprinted information on the back side includes information imprinted in at least one of the detachable regions.

12. The advertising card according to claim 1, wherein the detachable regions are formed by stamping the flexible sheet member to form separation lines.

13. The advertising card according to claim 1, wherein the detachable regions are formed by cutting away a portion of the flexible sheet member to form separation lines.

14. The advertising card according to claim 1, wherein the detachable regions are formed by molding the flexible sheet member to form separation lines.

15. The advertising card according to claim 1, wherein the detachable regions are formed by partially cutting the flexible sheet member to form separation lines.

16. The advertising card according to claim 1, wherein the detachable regions are formed by closely spaced perforations made in the flexible sheet member forming separation lines.

17. The advertising card according to claim 1, wherein the long edges of the detachable regions have a length selected from the group consisting of one, one-and-a-half, two, two—and-a-half, and three inches.

18. The advertising card according to claim 1, wherein the long edges of the detachable regions have a length of from one to three inches.

19. The advertising card according to claim 1, wherein the long edges of the detachable regions have a length of two inches.

20. The advertising card according to claim 1, wherein the detachable regions include one or more separation lines perpendicular to the long edges.

21. A device for use as a business card having one or more collar stays, comprising:
a card having opposing parallel first and second edges and opposing parallel third and fourth edges; and
one or more detachable regions, with each detachable region being rectangular and having four sides, with a long bilateral axis and a short bilateral axis, one side along the long bilateral axis forming a rounded point.

22. The device of claim 21, wherein the device is composed of cardboard stock.

23. The device of claim 21, wherein the device includes a front side and a back side, with printing on at least one side.

24. The device of claim 21, wherein the detachable regions are formed by partially cutting the flexible sheet member.

25. An advertising device having one or more collar stays formed therewith, the device comprising a substantially planar member delineating a geometric shape, at least one separation line formed within the member delineating a portion of the member in the shape of a collar stay, whereby the portion of the member can be separated from a remaining portion of the member to provide at least one collar stay.

26. The advertising device according to claim 25, wherein the substantially planar member is composed of one selected from the group consisting of: cardboard stock, plastic, cellulose-based material, and metal.

27. A method of forming one or more collar stays from a flexible sheet member comprising an advertising device, the method comprising:
providing a flexible sheet member;
forming separation lines by weakening the flexible sheet member delineating the shape of at least one collar stay; and
separating at least one collar stay from the flexible sheet member along the separation lines.

28. The method according to claim 27, wherein the weakening of the flexible sheet member is by stamping the flexible sheet member along the collar stay shapes delineated thereupon.

29. The method according to claim 27, wherein the weakening of the flexible sheet member is by cutting away a portion of the flexible sheet member along the collar stay shapes delineated thereupon.

30. The method according to claim 27, wherein the weakening of the flexible sheet member is by molding the flexible sheet member to form separation lines along the collar stay shapes delineated thereupon.
